(19) United States
(12) Patent Application Publication
(10) Pub. No.: US 2023/0216613 A1
(43) Pub. Date: Jul. 6, 2023

(54) COMBINED BLIND AND FEEDBACK BASED RETRANSMISSIONS

(71) Applicant: Lenovo (Singapore) PTE. LTD., New Tech Park (SG)

(72) Inventors: Prateek Basu Mallick, Dreieich (DE); Karthikeyan Ganesan, Clarendon Hills, IL (US); Joachim Loehr, Clarendon Hills, IL (US); Ravi Kuchibhotla, Chicago, IL (US)

(21) Appl. No.: 17/996,496

(22) PCT Filed: Apr. 16, 2021
(86) PCT No.: PCT/IB2021/053175

§ 371 Date: Oct. 18, 2022

Related U.S. Application Data
(60) Provisional application No. 63/012,102, filed on Apr. 18, 2020.

(51) Int. Cl. H04L 1/1825; H04L 1/1867

(52) U.S. Cl. CPC H04L 1/1825; H04L 1/189; H04L 1/1887

(57) ABSTRACT

Apparatuses, methods, and systems are disclosed for combined blind and feedback based retransmissions. One method (500) includes determining (502), for a first logical channel, a number of blind retransmissions to perform in a blind retransmission mode. The method (500) includes performing (504), by the first logical channel, the number of blind retransmissions in the blind retransmission mode. The method (500) includes, in response to performing the number of blind retransmission in the blind retransmission mode, switching (506), for the first logical channel, from the blind retransmission mode to a feedback based retransmission mode. The method (500) includes performing (508), by the first logical channel, one or more feedback based retransmissions in the feedback based retransmission mode.

### CROSS-REFERENCE TO RELATED APPLICATIONS

This application claims priority to U.S. Patent Application Ser. No. 63/012,102 entitled “APPARATUSES, METHODS, AND SYSTEMS FOR A MIXTURE OF BLIND RETRANSMISSION AND HARQ FEEDBACK-BASED RETRANSMISSION” and filed on Apr. 18, 2020 for Prateek Basu Mallick, which is incorporated herein by reference in its entirety.

### FIELD

The subject matter disclosed herein relates generally to wireless communications and more particularly relates to combined blind and feedback based retransmissions.

### BACKGROUND

In certain wireless communications networks, blind based retransmissions may be made. In some wireless communications networks, feedback based retransmission may be made. Retransmissions may be better if made using other methods.

### BRIEF SUMMARY

Methods for combined blind and feedback based retransmissions are disclosed. Apparatuses and systems also perform the functions of the methods. One embodiment of a method includes determining, for a first logical channel, a number of blind retransmissions to perform in a blind retransmission mode. In some embodiments, the method includes performing, by the first logical channel, the number of blind retransmissions in the blind retransmission mode. In various embodiments, the method includes, in response to performing the number of blind retransmission in the blind retransmission mode, switching, for the first logical channel, from the blind retransmission mode to a feedback based retransmission mode. In certain embodiments, the method includes performing, by the first logical channel, one or more feedback based retransmissions in the feedback based retransmission mode.

One apparatus for combined blind and feedback based retransmissions includes a processor that: determines, for a first logical channel, a number of blind retransmissions to perform in a blind retransmission mode; performs, by the first logical channel, the number of blind retransmissions in the blind retransmission mode; in response to performing the number of blind retransmission in the blind retransmission mode, switches, for the first logical channel, from the blind retransmission mode to a feedback based retransmission mode; and performs, by the first logical channel, one or more feedback based retransmissions in the feedback based retransmission mode.

One embodiment of a method for determining a minimum time duration includes determining a minimum time duration between a first resource for hybrid automatic repeat request transmission of a transport block and a second resource for hybrid automatic repeat request transmission of the transport block, wherein the minimum time duration comprises a sum of: a first time to receive hybrid automatic repeat request feedback; a second time to determine whether to perform retransmissions of the transport block; and a third time to retransmit the transport block.

One apparatus for determining a minimum time duration includes a processor that determines a minimum time duration between a first resource for hybrid automatic repeat request transmission of a transport block and a second resource for hybrid automatic repeat request transmission of the transport block, wherein the minimum time duration comprises a sum of: a first time to receive hybrid automatic repeat request feedback; a second time to determine whether to perform retransmissions of the transport block; and a third time to retransmit the transport block.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a wireless communication system for combined blind and feedback based retransmissions;

FIG. 2 is a schematic block diagram illustrating one embodiment of an apparatus that may be used for combined blind and feedback based retransmissions;

FIG. 3 is a schematic block diagram illustrating one embodiment of an apparatus that may be used for combined blind and feedback based retransmissions;

FIG. 4 is a diagram illustrating one embodiment of a method for mixed feedback based transmissions;

FIG. 5 is a flow chart diagram illustrating one embodiment of a method for combined blind and feedback based retransmissions; and

FIG. 6 is a flow chart diagram illustrating one embodiment of a method for determining a minimum time duration.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Certain of the functional units described in this specification may be labeled as modules, in order to more particularly emphasize their implementation independence. For example, a module may be implemented as a hardware circuit comprising custom very-large-scale integration (“VLSI”) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but may include disparate instructions stored in different locations which, when joined logically together, include the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be any number of lines and may be written in any combination of one or more programming languages including an object oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. The code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

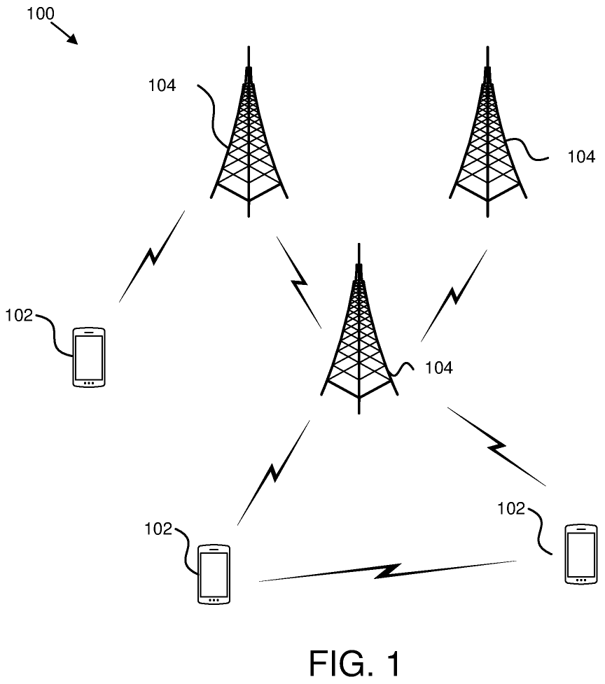

FIG. 1 depicts an embodiment of a wireless communication system 100 for combined blind and feedback based retransmissions. In one embodiment, the wireless communication system 100 includes remote units 102 and network units 104. Even though a specific number of remote units 102 and network units 104 are depicted in FIG. 1, one of skill in the art will recognize that any number of remote units 102 and network units 104 may be included in the wireless communication system 100.

In one embodiment, the remote units 102 may include computing devices, such as desktop computers, laptop computers, personal digital assistants (“PDAs”), tablet computers, smart phones, smart televisions (e.g., televisions connected to the Internet), set-top boxes, game consoles, security systems (including security cameras), vehicle on-board computers, network devices (e.g., routers, switches, modems), aerial vehicles, drones, or the like. In some embodiments, the remote units 102 include wearable devices, such as smart watches, fitness bands, optical head-mounted displays, or the like. Moreover, the remote units 102 may be referred to as subscriber units, mobiles, mobile stations, users, terminals, mobile terminals, fixed terminals, subscriber stations, UE, user terminals, a device, or by other terminology used in the art. The remote units 102 may communicate directly with one or more of the network units 104 via UL communication signals. In certain embodiments, the remote units 102 may communicate directly with other remote units 102 via sidelink communication.

The network units 104 may be distributed over a geographic region. In certain embodiments, a network unit 104 may also be referred to and/or may include one or more of an access point, an access terminal, a base, a base station, a core network (“CN”), a radio network entity, a Node-B, an evolved node-B (“eNB”), a 5G node-B (“gNB”), a Home Node-B, a relay node, a device, a core network, an aerial server, a radio access node, an access point (“AP”), new radio (“NR”), a network entity, an access and mobility management function (“AMF”), a unified data management (“UDM”), a unified data repository (“UDR”), a UDM/UDR, a policy control function (“PCF”), a radio access network (“RAN”), a network slice selection function (“NSSF”), an operations, administration, and management (“OAM”), a session management function (“SMF”), a user plane function (“UPF”), an application function, an authentication server function (“AUSF”), security anchor functionality (“SEAF”), trusted non-3GPP gateway function (“TNGF”), or by any other terminology used in the art. The network units 104 are generally part of a radio access network that includes one or more controllers communicably coupled to one or more corresponding network units 104. The radio access network is generally communicably coupled to one or more core networks, which may be coupled to other networks, like the Internet and public switched telephone networks, among other networks. These and other elements of radio access and core networks are not illustrated but are well known generally by those having ordinary skill in the art.

In one implementation, the wireless communication system 100 is compliant with NR protocols standardized in third generation partnership project (“3GPP”), wherein the network unit 104 transmits using an OFDM modulation scheme on the downlink (“DL”) and the remote units 102 transmit on the uplink (“UL”) using a single-carrier frequency division multiple access (“SC-FDMA”) scheme or an orthogonal frequency division multiplexing (“OFDM”) scheme. More generally, however, the wireless communication system 100 may implement some other open or proprietary communication protocol, for example, WiMAX, institute of electrical and electronics engineers (“IEEE”) 802.11 variants, global system for mobile communications (“GSM”), general packet radio service (“GPRS”), universal mobile telecommunications system (“UMTS”), long term evolution (“LTE”) variants, code division multiple access 2000 (“CDMA2000”), Bluetooth®, ZigBee, Sigfoxx, among other protocols. The present disclosure is not intended to be limited to the implementation of any particular wireless communication system architecture or protocol.

The network units 104 may serve a number of remote units 102 within a serving area, for example, a cell or a cell sector via a wireless communication link. The network units 104 transmit DL communication signals to serve the remote units 102 in the time, frequency, and/or spatial domain.

In various embodiments, a remote unit 102 and/or a network unit 104 may determine, for a first logical channel, a number of blind retransmissions to perform in a blind retransmission mode. In some embodiments, the remote unit 102 and/or the network unit 104 may perform, by the first logical channel, the number of blind retransmissions in the blind retransmission mode. In various embodiments, the remote unit 102 and/or the network unit 104 may, in response to performing the number of blind retransmission in the blind retransmission mode, switch, for the first logical channel, from the blind retransmission mode to a feedback based retransmission mode. In certain embodiments, the remote unit 102 and/or the network unit 104 may perform, by the first logical channel, one or more feedback based retransmissions in the feedback based retransmission mode. Accordingly, the remote unit 102 and/or the network unit 104 may be used for combined blind and feedback based retransmissions.

In certain embodiments, a remote unit 102 and/or a network unit 104 may determine a minimum time duration between a first resource for hybrid automatic repeat request transmission of a transport block and a second resource for hybrid automatic repeat request transmission of the transport block, wherein the minimum time duration comprises a sum of: a first time to receive hybrid automatic repeat request feedback; a second time to determine whether to perform retransmissions of the transport block; and a third time to retransmit the transport block. Accordingly, the remote unit 102 and/or the network unit 104 may be used for determining a minimum time duration.

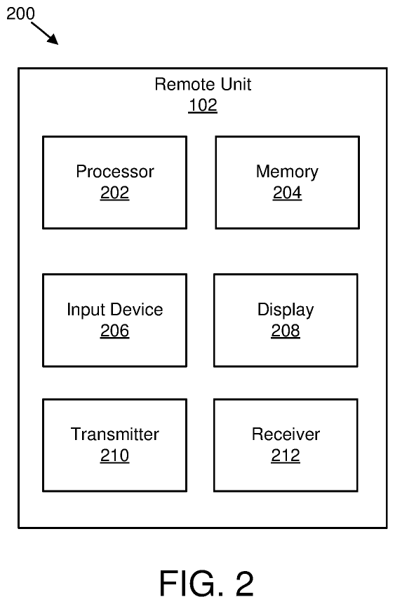

FIG. 2 depicts one embodiment of an apparatus 200 that may be used for combined blind and feedback based retransmissions. The apparatus 200 includes one embodiment of the remote unit 102. Furthermore, the remote unit 102 may include a processor 202, a memory 204, an input device 206, a display 208, a transmitter 210, and a receiver 212. In some embodiments, the input device 206 and the display 208 are combined into a single device, such as a touchscreen. In certain embodiments, the remote unit 102 may not include any input device 206 and/or display 208. In various embodiments, the remote unit 102 may include one or more of the processor 202, the memory 204, the transmitter 210, and the receiver 212, and may not include the input device 206 and/or the display 208.

The processor 202, in one embodiment, may include any known controller capable of executing computer-readable instructions and/or capable of performing logical operations. For example, the processor 202 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 202 executes instructions stored in the memory 204 to perform the methods and routines described herein. The processor 202 is communicatively coupled to the memory 204, the input device 206, the display 208, the transmitter 210, and the receiver 212.

The memory 204, in one embodiment, is a computer readable storage medium. In some embodiments, the memory 204 includes volatile computer storage media. For example, the memory 204 may include a RAM, including dynamic RAM (“DRAM”), synchronous dynamic RAM (“SDRAM”), and/or static RAM (“SRAM”). In some embodiments, the memory 204 includes non-volatile computer storage media. For example, the memory 204 may include a hard disk drive, a flash memory, or any other suitable non-volatile computer storage device. In some embodiments, the memory 204 includes both volatile and non-volatile computer storage media. In some embodiments, the memory 204 also stores program code and related data, such as an operating system or other controller algorithms operating on the remote unit 102.

The input device 206, in one embodiment, may include any known computer input device including a touch panel, a button, a keyboard, a stylus, a microphone, or the like. In some embodiments, the input device 206 may be integrated with the display 208, for example, as a touchscreen or similar touch-sensitive display. In some embodiments, the input device 206 includes a touchscreen such that text may be input using a virtual keyboard displayed on the touchscreen and/or by handwriting on the touchscreen. In some embodiments, the input device 206 includes two or more different devices, such as a keyboard and a touch panel.

The display 208, in one embodiment, may include any known electronically controllable display or display device. The display 208 may be designed to output visual, audible, and/or haptic signals. In some embodiments, the display 208 includes an electronic display capable of outputting visual data to a user. For example, the display 208 may include, but is not limited to, a liquid crystal display (“LCD”), a light emitting diode (“LED”) display, an organic light emitting diode (“OLED”) display, a projector, or similar display device capable of outputting images, text, or the like to a user. As another, non-limiting, example, the display 208 may include a wearable display such as a smart watch, smart glasses, a heads-up display, or the like. Further, the display 208 may be a component of a smart phone, a personal digital assistant, a television, a table computer, a notebook (laptop) computer, a personal computer, a vehicle dashboard, or the like.

In certain embodiments, the display 208 includes one or more speakers for producing sound. For example, the display 208 may produce an audible alert or notification (e.g., a beep or chime). In some embodiments, the display 208 includes one or more haptic devices for producing vibrations, motion, or other haptic feedback. In some embodiments, all or portions of the display 208 may be integrated with the input device 206. For example, the input device 206 and display 208 may form a touchscreen or similar touch-sensitive display. In other embodiments, the display 208 may be located near the input device 206.

In various embodiments, the processor 202 may: determine, for a first logical channel, a number of blind retransmissions to perform in a blind retransmission mode; perform, by the first logical channel, the number of blind retransmissions in the blind retransmission mode; in response to performing the number of blind retransmission in the blind retransmission mode, switch, for the first logical channel, from the blind retransmission mode to a feedback based retransmission mode; and perform, by the first logical channel, one or more feedback based retransmissions in the feedback based retransmission mode.

In certain embodiments, the processor 202 determines a minimum time duration between a first resource for hybrid automatic repeat request transmission of a transport block and a second resource for hybrid automatic repeat request transmission of the transport block, wherein the minimum time duration comprises a sum of: a first time to receive hybrid automatic repeat request feedback; a second time to determine whether to perform retransmissions of the transport block; and a third time to retransmit the transport block.

Although only one transmitter 210 and one receiver 212 are illustrated, the remote unit 102 may have any suitable number of transmitters 210 and receivers 212. The transmitter 210 and the receiver 212 may be any suitable type of transmitters and receivers. In one embodiment, the transmitter 210 and the receiver 212 may be part of a transceiver.

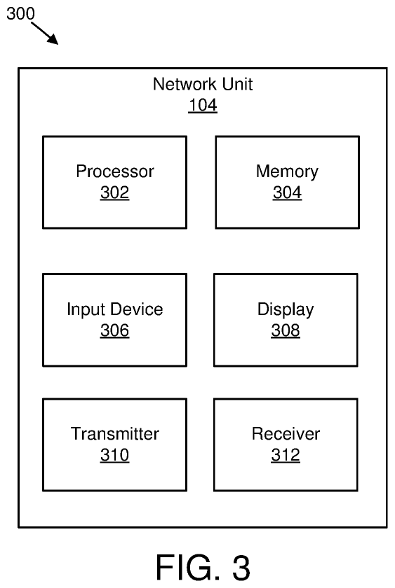

FIG. 3 depicts one embodiment of an apparatus 300 that may be used for combined blind and feedback based retransmissions. The apparatus 300 includes one embodiment of the network unit 104. Furthermore, the network unit 104 may include a processor 302, a memory 304, an input device 306, a display 308, a transmitter 310, and a receiver 312. As may be appreciated, the processor 302, the memory 304, the input device 306, the display 308, the transmitter 310, and the receiver 312 may be substantially similar to the processor 202, the memory 204, the input device 206, the display 208, the transmitter 210, and the receiver 212 of the remote unit 102, respectively.

In various embodiments, the processor 302 may: determine, for a first logical channel, a number of blind retransmissions to perform in a blind retransmission mode; perform, by the first logical channel, the number of blind retransmissions in the blind retransmission mode; in response to performing the number of blind retransmission in the blind retransmission mode, switch, for the first logical channel, from the blind retransmission mode to a feedback based retransmission mode; and perform, by the first logical channel, one or more feedback based retransmissions in the feedback based retransmission mode.

In certain embodiments, the processor 302 determines a minimum time duration between a first resource for hybrid automatic repeat request transmission of a transport block and a second resource for hybrid automatic repeat request transmission of the transport block, wherein the minimum time duration comprises a sum of: a first time to receive hybrid automatic repeat request feedback; a second time to determine whether to perform retransmissions of the transport block; and a third time to retransmit the transport block.

In various embodiments, such as in new radio (“NR”) vehicle-to-everything (“V2X”), a transmitting user equipment (“UE”) may choose to seek hybrid automatic repeat request (“HARQ”) feedback to determine if further retransmission needs to be made or may make a number of blind retransmissions (e.g., retransmissions without seeking HARQ feedback).

In certain embodiments, such as in sidelink (“SL”) V2X, retransmissions may use a mix of blind and feedback-based retransmissions of the same transport block (“TB”) to achieve a sidelink performance benefit. In such embodiments, although it is possible to dynamically enable and/or disable (e.g., seek and/or not-seek) SL HARQ feedback in SL physical layer (“PHY”) using sidelink control information, a number of issues may result (e.g., a medium access control (“MAC”) layer may not be sure why it has not received feedback if feedback is expected and may make a wrong decision (e.g., conclude to make a retransmission); or the MAC layer may receive feedback that is not expected since no feedback was sought. Moreover, a radio resource control (“RRC”) configuration of enabling and/or disabling HARQ feedback per logical channel may not support a mix of blind and HARQ feedback-based retransmissions.

In some embodiments, a mixture of blind retransmission and HARQ feedback-based transmission for a TB if a logical channel (“LCH”) is configured by RRC as SL HARQ enable and/or disable.

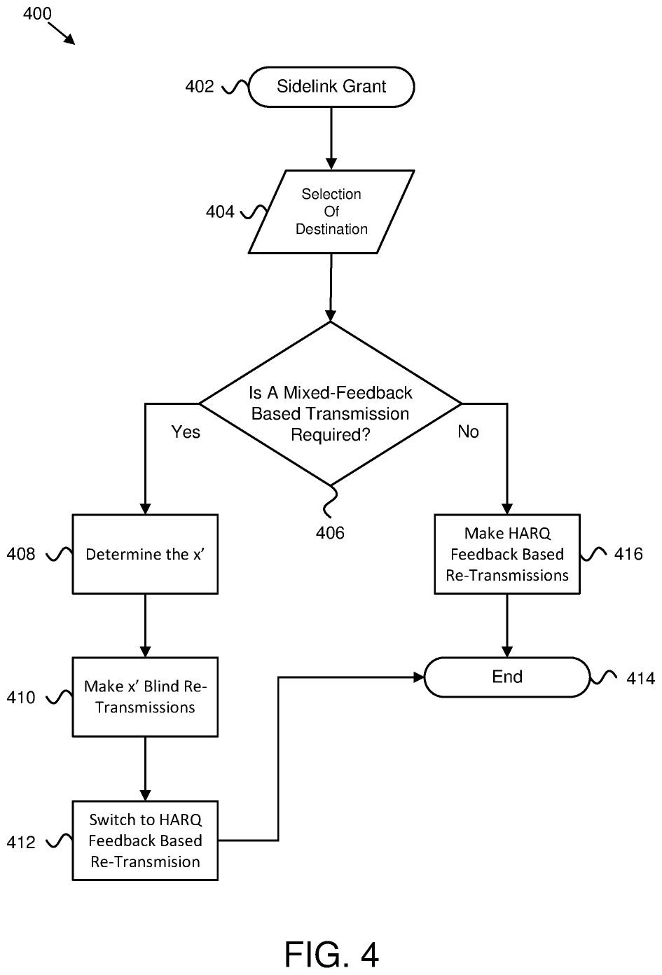

FIG. 4 is a diagram illustrating one embodiment of a method 400 for mixed feedback based transmissions. The method 400 includes receiving 402 a sidelink grant and selecting 404 a destination. The method 400 also includes determining 406 whether a mixed-feedback (e.g., combination of blind retransmissions and feedback-based retransmissions) based transmission is required. If a mixed-feedback based transmission is required, the method 400 includes determining 408 x′. x′ is the number of blind retransmissions to make. The method 400 then includes making 410 the x′ blind re-transmissions. In response to completing the x′ blind re-transmissions, the method 400 switches 412 to HARQ feedback based re-transmission, the method 400 ends 414. If a mixed-feedback based transmission is not required, the method 400 includes making 416 HARQ feedback based retransmissions, and the method 400 ends 414.

In some embodiments, there is a new RRC configuration that enables some LCHs to operate in a mixed feedback mode (e.g., mode with a combination of blind retransmissions and feedback-based retransmissions) by using a new code point in the RRC LCH SL HARQ configuration or a no-feedback mode is used. The no-feedback mode transmissions (e.g., blind retransmissions) may be performed for a predetermined or variable number of transmissions. After the predetermined or variable number (x′) of transmissions, the transmitter may switch to and may stay in a mode with HARQ feedback. The number x′ may be preconfigured or may be determined using various methods, such as those described herein. The variability of the number of no-feedback transmissions may be based on changing channel conditions and so forth.

In various embodiments, LCHs that operate in the mixed feedback mode may be considered for resource allocation together with other logical channels with HARQ feedback enabled or disabled.

In certain embodiments, LCHs that operate in the mixed feedback mode may be considered for resource allocation together only with other logical channels with same HARQ feedback mode (e.g., with logical channels in the mixed feedback mode).

In a first example, feedback may be enabled for a first LCH and a second LCH may be in a mixed feedback mode. In this example, the first and second LCHs, included of the same transport block, may make a certain number of blind retransmissions (“BRs”) (e.g., x′) and then one feedback (“FB”) based HARQ retransmission seeking HARQ feedback (“HF”). This may ensure that every intended receiver that has not yet successfully received a physical sidelink shared channel (“PSSCH”) transmission is able to provide negative acknowledgement (“NACK”) feedback, but also may avoid decoding an already successfully received PSSCH transmission and feedback transmission by other intended receivers.

In a second example, feedback may be disabled for a first LCH and a second LCH may be in a mixed feedback mode. In one implementation of this example, only BRs may be made by the first and second LCHs, included in the same transport block. In another implementation of this example, a certain number of blind retransmission may be made, then one FB based HARQ retransmission is made by the first and second LCHs, included in the same transport block.

In a third example, two LCHs may be in a mixed feedback mode. In this example, both LCHs, included in the same transport block, may make a certain number of BRs (e.g., x′) and then one FB based HARQ retransmission seeking HF.

Various examples are shown in Table 1.

TABLE 1

| LCH1 | LCH2 | Transmission + Retransmission |
|---|---|---|
| Mixed | Enabled | n Blind Retransmissions + 1 or more feedback-based |
| | | Retransmissions |
| Mixed | Enabled | only feedback-based retransmission |
| Mixed | Disabled | Only Blind Retransmissions |
| Mixed | Disabled | n Blind Retransmissions + 1 or more feedback-based |
| | | Retransmissions |

In some embodiments, there may be no new RRC configuration allowing some LCHs to operate in mixed feedback mode (or equivalently no-feedback mode). In such embodiments, only the following two cases arise: 1) a TB containing only feedback enabled LCHs in which a certain number of BRs are made (e.g., x′) and then one FB based HARQ retransmission is made seeking HF; and 2) a TB containing only feedback disabled LCHs: in one implementation, only BRs may be made—in another implementation, a certain number of blind retransmission may be made, then one FB based HARQ retransmission is made.

In various embodiments, if a requested feedback option is HF Option 2, then a transmit or transmitter (“TX”) UE counts a number of NACKs and/or discontinuous transmission (“DTX”) feedbacks (e.g., total_failures). If the total_failures exceeds a threshold (e.g., threshold_total_failures), the TX UE makes ‘x’ blind retransmissions.

In certain embodiments, a mixed HARQ mode of operation is implemented as HARQ enabled transmissions with UE autonomously triggered retransmission without having received HARQ feedback from RX UEs.

In some embodiments, if a MAC layer has determined as a result of logical channel prioritization (“LCP”) that a TB contains only LCHs with HF enabled, the MAC layer delivers the TB to a PHY layer and the PHY layer may further decide to transmit the TB in a “mixed mode” based on a current channel condition (e.g., priority of the TB, etc.). In one example, in mixed mode a first x HARQ transmissions of a TB do not request a HARQ feedback in sidelink control information (“SCI”) and for an X+1 transmission, a UE may request in SCI for HARQ feedback from receiver UEs. For the first ‘X’ retransmission(s), the PHY layer will trigger some autonomous retransmissions from the MAC layer—without receiving a HARQ feedback on a physical sidelink feedback channel (“PSFCH”) from any receiver or receiving (“RX”) UE—by indicating “NACK” internally to the MAC layer for the determined number of BRs (e.g., x′ transmissions).

In such embodiments, from the MAC layer point of view, the “mixed mode” operation is considered like standard HARQ enabled transmissions. Thus, the MAC layer is unaware of whether the HARQ feedback delivered from the PHY layer was triggering internally and/or autonomously or whether it was derived based on received HARQ feedback on PSFCH from receiving UEs.

In some embodiments, if a MAC layer has determined, as a result of LCP, that a TB contains only LCHs with HF disabled, the MAC layer delivers the TB to the PHY layer and the PHY layer may further decide to transmit the TB in the “mixed mode” based on current channel conditions, a priority of the TB, and so forth. In one example, in mixed feedback mode, a first x HARQ transmissions of a TB do not request a HARQ feedback in SCI and for an X+1 transmission (and later retransmissions) request in SCI for HARQ feedback from the receiver UEs. For the first X+1 retransmission (and later retransmissions), the PHY layer may initiate HARQ feedback based retransmissions. A retransmission may be made when a “NACK” feedback or a DTX is received from one or more receivers, otherwise (e.g., all received HARQ feedbacks are acknowledgement (“ACK”) feedback) no further retransmissions are made. From the MAC layer point of view, the “mixed mode” is considered to be a normal HARQ enabled transmission.

In various embodiments, a minimum time duration may be defined to denote a minimum time period between two HARQ transmissions of one transport block and may be considered by a TX UE during SL resource selection.

In certain embodiments, SL Resources for all HARQ transmissions (or retransmissions) of a TB may be chosen by the TX UE such that in the time domain that there is sufficient time for the TX UE to receive a HARQ feedback for a HARQ transmission of a TB on the PSFCH from RX UEs and to decide whether to perform further HARQ transmissions (or retransmissions) for the TB and to execute the HARQ retransmissions. As may be appreciated, a new minimum time duration parameter may be beneficial for scenarios in which a MAC layer of the TX UE selects SL resources for x′ number of blind HARQ transmissions of TB and the PHY layer of the TX UE decides to ask for HARQ feedback from receiving UEs after the yth transmission, y being smaller than x, to determine whether further HARQ transmissions are necessary.

In some embodiments, a PHY layer of the TX UE indicates to a MAC layer that for the SL resource selection there should be sufficient time between the transmissions of the TB to allow for gathering HARQ feedback. A minimum time distance between HARQ transmissions of a TB may be signaled to the MAC layer from the PHY layer as a new input parameter for the SL resource selection procedure. In one example, a minimum processing time may denote a minimum time between two HARQ transmission similar to a HARQ round trip time (“RTT”) value or a K3 value for the Uu interface. In various embodiments, a new parameter minimum time distance between HARQ transmissions of a TB may be a fixed predefined value or may be defined according to the UE capability.

In certain embodiments, a PHY layer may only be allowed to use a mixed mode of operation if LCP results in a TB with LCHs configured for the mixed mode. In such embodiments, RRC may configure some LCH with the “mixed feedback mode.”

In various embodiments, x′ may be determined as follows: 1) a total number of transmissions may depend on one or more of a link budget requirement that may be determined and/or mapped from minimum communication range (“MCR”), SL pathloss (e.g., unicast), allowed MCS (e.g., code rate), transmit power of a TX UE (e.g., a total number of transmissions may vary for MCR ‘a’ and MCR ‘b’, for a groupcast communication the worst pathloss is used if available); 2) a total number of BRs and HARQ feedback-based transmissions (“HFBTs”) may depend on a total reliability to be achieved given a latency boundary (e.g., packet delay budget (“PDB”)).

In one example, a first UE determines a number of BRs to be performed for a given PDB then the UE decides about a HARQ feedback enabled retransmission.

In another example, PDB or remaining PDB may be used to determine how many feedback based transmissions could be used in view of RTT between a transmission and reception of the corresponding HARQ feedback. If this would be less than that is required to fulfill a given reliability for a given MCR, then the TX UE may save time by making certain blind transmissions (or retransmissions). As may be appreciated, the terms transmission and retransmission may be used interchangeably herein. A transmission may be a first transmission or a retransmission, and a retransmission may refer to a first transmission.

Table 2 illustrates one example of embodiments described above.

TABLE 2

| Reliability (LCH priority) | MCR #1 | MCR #2 |
|---|---|---|
| 99%, 5 ms PDB | 3 BT | 5 BT |
| 99.9%, 10 ms PDB | 4 BT | 6 BT |
| 99.999%, 10 ms PDB | 4 BT, 1 HFBT | 5 BT, 1 HFBT |
| 99.999%, 5 ms PDB | 5 BT, 1 HFBT | 6 BT, 1 HFBT |

In certain embodiments, x′ may be determined as a floor value of a HARQ operating point. The floor value may mean the biggest integer value that is smaller (or equal to) than the HARQ operating point. The HARQ operating point itself may be determined using statistical observation on a PC5 link for the same destination or for other destinations of the same or different cast-types.

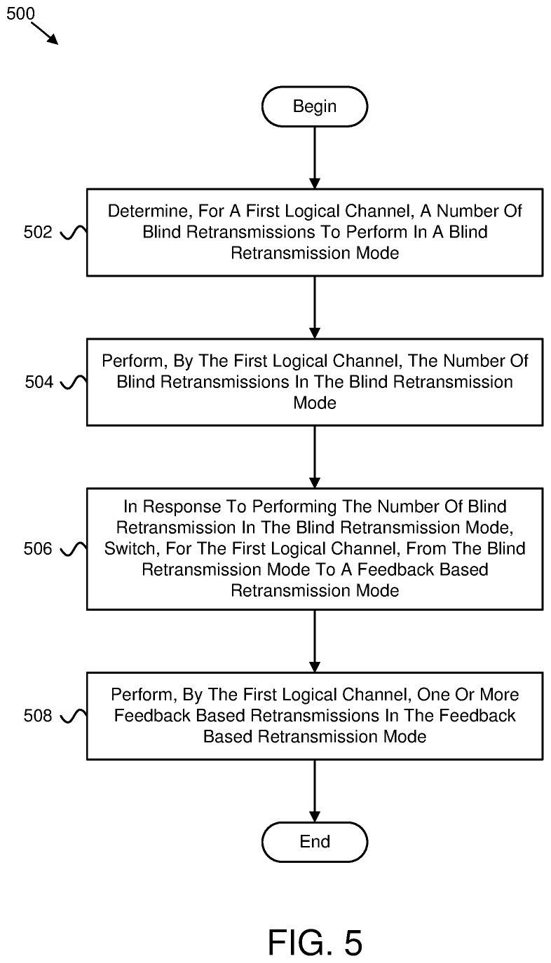

FIG. 5 is a flow chart diagram illustrating one embodiment of a method 500 for combined blind and feedback based retransmissions. In some embodiments, the method 500 is performed by an apparatus, such as the remote unit 102 and/or the network unit 104. In certain embodiments, the method 500 may be performed by a processor executing program code, for example, a microcontroller, a microprocessor, a CPU, a GPU, an auxiliary processing unit, a FPGA, or the like.

In various embodiments, the method 500 includes determining 502, for a first logical channel, a number of blind retransmissions to perform in a blind retransmission mode. In some embodiments, the method 500 includes performing 504, by the first logical channel, the number of blind retransmissions in the blind retransmission mode. In various embodiments, the method 500 includes, in response to performing the number of blind retransmission in the blind retransmission mode, switching 506, for the first logical channel, from the blind retransmission mode to a feedback based retransmission mode. In certain embodiments, the method 500 includes performing 508, by the first logical channel, one or more feedback based retransmissions in the feedback based retransmission mode.

In certain embodiments, the first logical channel is part of a plurality of logical channels, and the plurality of logical channels comprises a second logical channel that only operates in the feedback based retransmission mode. In some embodiments, the second logical channel operates with feedback enabled. In various embodiments, the second logical channel operates with feedback disabled.

In one embodiment, the one or more feedback based retransmissions in the feedback based retransmission mode comprises only one feedback based retransmission. In certain embodiments, the number of blind retransmissions is predetermined, variable, calculated, or some combination thereof. In some embodiments, the first logical channel is part of a plurality of logical channels, the plurality of logical channels is used for resource allocation of the first logical channel, and the plurality of logical channels comprises at least one channel that only operates in the feedback based retransmission mode.

In various embodiments, the first logical channel is part of a plurality of logical channels, the plurality of logical channels is used for resource allocation of the first logical channel, and the plurality of logical channels comprises only channels that operate in both of the blind retransmission mode and the feedback based retransmission mode. In one embodiment, the method 500 further comprises determining whether to operate in a mixed mode comprising the blind retransmission mode and the feedback based retransmission mode. In certain embodiments, determining whether to operate in the mixed mode comprises determining whether to operate in the mixed mode based on a channel condition, a priority of a transport block, or a combination thereof.

In some embodiments, performing the number of blind retransmissions in the blind retransmission mode comprises a physical layer indicating a negative acknowledgment to a medium access control layer for each blind retransmission of the number of blind retransmissions. In various embodiments, the number of blind retransmissions is based on a link budget requirement, a sidelink pathloss, a code rate, a transmit power, a reliability, a packet delay budget, a remaining packet delay budget, or a combination thereof.

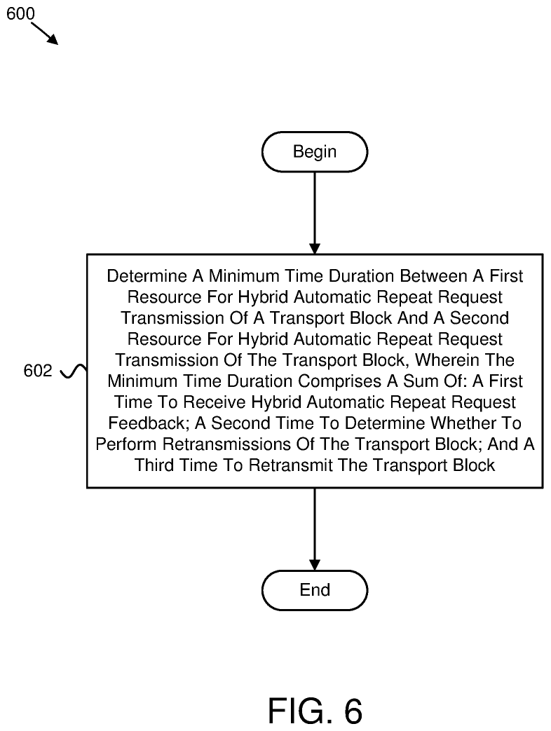

FIG. 6 is a flow chart diagram illustrating one embodiment of a method 600 for determining a minimum time duration. In some embodiments, the method 600 is performed by an apparatus, such as the remote unit 102 and/or the network unit 104. In certain embodiments, the method 600 may be performed by a processor executing program code, for example, a microcontroller, a microprocessor, a CPU, a GPU, an auxiliary processing unit, a FPGA, or the like.

In various embodiments, the method 600 includes determining 602 a minimum time duration between a first resource for hybrid automatic repeat request transmission of a transport block and a second resource for hybrid automatic repeat request transmission of the transport block, wherein the minimum time duration comprises a sum of: a first time to receive hybrid automatic repeat request feedback; a second time to determine whether to perform retransmissions of the transport block; and a third time to retransmit the transport block.

In certain embodiments, the method 600 further comprises sending the minimum time duration from a physical layer to a medium access control layer. In some embodiments, the method 600 further comprises selecting the first resource and the second resource based on the minimum time duration. In various embodiments, a medium access control layer selects the first resource and the second resource.

In one embodiment, a method comprises: determining, for a first logical channel, a number of blind retransmissions to perform in a blind retransmission mode; performing, by the first logical channel, the number of blind retransmissions in the blind retransmission mode; in response to performing the number of blind retransmission in the blind retransmission mode, switching, for the first logical channel, from the blind retransmission mode to a feedback based retransmission mode; and performing, by the first logical channel, one or more feedback based retransmissions in the feedback based retransmission mode.

In certain embodiments, the first logical channel is part of a plurality of logical channels, and the plurality of logical channels comprises a second logical channel that only operates in the feedback based retransmission mode.

In some embodiments, the second logical channel operates with feedback enabled.

In various embodiments, the second logical channel operates with feedback disabled.

In one embodiment, the one or more feedback based retransmissions in the feedback based retransmission mode comprises only one feedback based retransmission.

In certain embodiments, the number of blind retransmissions is predetermined, variable, calculated, or some combination thereof.

In some embodiments, the first logical channel is part of a plurality of logical channels, the plurality of logical channels is used for resource allocation of the first logical channel, and the plurality of logical channels comprises at least one channel that only operates in the feedback based retransmission mode.

In various embodiments, the first logical channel is part of a plurality of logical channels, the plurality of logical channels is used for resource allocation of the first logical channel, and the plurality of logical channels comprises only channels that operate in both of the blind retransmission mode and the feedback based retransmission mode.

In one embodiment, the method further comprises determining whether to operate in a mixed mode comprising the blind retransmission mode and the feedback based retransmission mode.

In certain embodiments, determining whether to operate in the mixed mode comprises determining whether to operate in the mixed mode based on a channel condition, a priority of a transport block, or a combination thereof.

In some embodiments, performing the number of blind retransmissions in the blind retransmission mode comprises a physical layer indicating a negative acknowledgment to a medium access control layer for each blind retransmission of the number of blind retransmissions.

In various embodiments, the number of blind retransmissions is based on a link budget requirement, a sidelink pathloss, a code rate, a transmit power, a reliability, a packet delay budget, a remaining packet delay budget, or a combination thereof.

In one embodiment, an apparatus comprises: a processor that: determines, for a first logical channel, a number of blind retransmissions to perform in a blind retransmission mode; performs, by the first logical channel, the number of blind retransmissions in the blind retransmission mode; in response to performing the number of blind retransmission in the blind retransmission mode, switches, for the first logical channel, from the blind retransmission mode to a feedback based retransmission mode; and performs, by the first logical channel, one or more feedback based retransmissions in the feedback based retransmission mode.

In certain embodiments, the first logical channel is part of a plurality of logical channels, and the plurality of logical channels comprises a second logical channel that only operates in the feedback based retransmission mode.

In some embodiments, the second logical channel operates with feedback enabled.

In various embodiments, the second logical channel operates with feedback disabled.

In one embodiment, the one or more feedback based retransmissions in the feedback based retransmission mode comprises only one feedback based retransmission.

In certain embodiments, the number of blind retransmissions is predetermined, variable, calculated, or some combination thereof.

In some embodiments, the first logical channel is part of a plurality of logical channels, the plurality of logical channels is used for resource allocation of the first logical channel, and the plurality of logical channels comprises at least one channel that only operates in the feedback based retransmission mode.

In various embodiments, the first logical channel is part of a plurality of logical channels, the plurality of logical channels is used for resource allocation of the first logical channel, and the plurality of logical channels comprises only channels that operate in both of the blind retransmission mode and the feedback based retransmission mode.

In one embodiment, the processor determines whether to operate in a mixed mode comprising the blind retransmission mode and the feedback based retransmission mode.

In certain embodiments, the processor determining whether to operate in the mixed mode comprises the processor determining whether to operate in the mixed mode based on a channel condition, a priority of a transport block, or a combination thereof.

In some embodiments, the processor performing the number of blind retransmissions in the blind retransmission mode comprises a physical layer indicating a negative acknowledgment to a medium access control layer for each blind retransmission of the number of blind retransmissions.

In various embodiments, the number of blind retransmissions is based on a link budget requirement, a sidelink pathloss, a code rate, a transmit power, a reliability, a packet delay budget, a remaining packet delay budget, or a combination thereof.

In one embodiment, a method comprises: determining a minimum time duration between a first resource for hybrid automatic repeat request transmission of a transport block and a second resource for hybrid automatic repeat request transmission of the transport block, wherein the minimum time duration comprises a sum of: a first time to receive hybrid automatic repeat request feedback; a second time to determine whether to perform retransmissions of the transport block; and a third time to retransmit the transport block.

In certain embodiments, the method further comprises sending the minimum time duration from a physical layer to a medium access control layer.

In some embodiments, the method further comprises selecting the first resource and the second resource based on the minimum time duration.

In various embodiments, a medium access control layer selects the first resource and the second resource.

In one embodiment, an apparatus comprises: a processor that determines a minimum time duration between a first resource for hybrid automatic repeat request transmission of a transport block and a second resource for hybrid automatic repeat request transmission of the transport block, wherein the minimum time duration comprises a sum of: a first time to receive hybrid automatic repeat request feedback; a second time to determine whether to perform retransmissions of the transport block; and a third time to retransmit the transport block.

In certain embodiments, the processor sends the minimum time duration from a physical layer to a medium access control layer.

In some embodiments, the processor selects the first resource and the second resource based on the minimum time duration.

In various embodiments, a medium access control layer selects the first resource and the second resource.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A method comprising:
determining, for a first logical channel, a number of blind retransmissions to perform in a blind retransmission mode;
performing, by the first logical channel, the number of blind retransmissions in the blind retransmission mode;
in response to performing the number of blind retransmission in the blind retransmission mode, switching, for the first logical channel, from the blind retransmission mode to a feedback based retransmission mode; and
performing, by the first logical channel, one or more feedback based retransmissions in the feedback based retransmission mode.

2. The method of claim 1, wherein the first logical channel is part of a plurality of logical channels, and the plurality of logical channels comprises a second logical channel that only operates in the feedback based retransmission mode.

3. The method of claim 2, wherein the second logical channel operates with feedback enabled.

4. The method of claim 2, wherein the second logical channel operates with feedback disabled.

5. The method of claim 1, wherein the one or more feedback based retransmissions in the feedback based retransmission mode comprises only one feedback based retransmission.

6. The method of claim 1, wherein the number of blind retransmissions is predetermined, variable, calculated, or some combination thereof.

7. The method of claim 1, wherein the first logical channel is part of a plurality of logical channels, the plurality of logical channels is used for resource allocation of the first logical channel, and the plurality of logical channels comprises at least one channel that only operates in the feedback based retransmission mode.

8. The method of claim 1, wherein the first logical channel is part of a plurality of logical channels, the plurality of logical channels is used for resource allocation of the first logical channel, and the plurality of logical channels comprises only channels that operate in both of the blind retransmission mode and the feedback based retransmission mode.

9. The method of claim 1, further comprising determining whether to operate in a mixed mode comprising the blind retransmission mode and the feedback based retransmission mode.

10. The method of claim 9, wherein determining whether to operate in the mixed mode comprises determining whether to operate in the mixed mode based on a channel condition, a priority of a transport block, or a combination thereof.

11. The method of claim 1, wherein performing the number of blind retransmissions in the blind retransmission mode comprises a physical layer indicating a negative acknowledgment to a medium access control layer for each blind retransmission of the number of blind retransmissions.

12. The method of claim 1, wherein the number of blind retransmissions is based on a link budget requirement, a sidelink pathloss, a code rate, a transmit power, a reliability, a packet delay budget, a remaining packet delay budget, or a combination thereof.

13. An apparatus comprising:
a processor that:
determines, for a first logical channel, a number of blind retransmissions to perform in a blind retransmission mode;
performs, by the first logical channel, the number of blind retransmissions in the blind retransmission mode;
in response to performing the number of blind retransmission in the blind retransmission mode, switches, for the first logical channel, from the blind retransmission mode to a feedback based retransmission mode; and
performs, by the first logical channel, one or more feedback based retransmissions in the feedback based retransmission mode.

14. (canceled)

15. (canceled)

16. (canceled)

17. (canceled)

18. An apparatus comprising:
a processor that determines a minimum time duration between a first resource for hybrid automatic repeat request transmission of a transport block and a second resource for hybrid automatic repeat request transmission of the transport block, wherein the minimum time duration comprises a sum of:
a first time to receive hybrid automatic repeat request feedback;
a second time to determine whether to perform retransmissions of the transport block; and
a third time to retransmit the transport block.

19. The apparatus of claim 18, wherein the processor sends the minimum time duration from a physical layer to a medium access control layer.

20. The apparatus of claim 18, wherein the processor selects the first resource and the second resource based on the minimum time duration.

21. The apparatus of claim 13, wherein the first logical channel is part of a plurality of logical channels, and the plurality of logical channels comprises a second logical channel that only operates in the feedback based retransmission mode.

22. The apparatus of claim 21, wherein the second logical channel operates with feedback enabled.

23. The apparatus of claim 21, wherein the second logical channel operates with feedback disabled.

24. The apparatus of claim 13, wherein the one or more feedback based retransmissions in the feedback based retransmission mode comprises only one feedback based retransmission.
